(19) United States
(12) Patent Application Publication
(10) Pub. No.: US 2020/0122380 A1
(43) Pub. Date: Apr. 23, 2020

(54) IMPROVED PROCESS FOR EXTRUSION COATING OF FIBER-BASED SUBSTRATES

(71) Applicant: Stora Enso OYJ, Helsinki (FI)

(72) Inventors: Jari RÄSÄNEN, Imatra (FI); Kimmo NEVALAINEN, Kotka (FI); Ville RIBU, Lappeenranta (FI); Esa SUOKAS, Tampere (FI); Jurkka KUUSIPALO, Tampere (FI)

(73) Assignee: Stora Enso OYJ, Helsinki (FI)

(21) Appl. No.: 16/500,757

(22) PCT Filed: May 9, 2018
(86) PCT No.: PCT/IB2018/053214

§ 371 Date: Oct. 3, 2019

(30) Foreign Application Priority Data
May 15, 2017 (SE) 1750595-9

(51) Int. Cl. B29C 48/40; B32B 27/10

(52) U.S. Cl. CPC B29C 48/40; B32B 27/32; B32B 27/10

(57) ABSTRACT

The present invention relates to a process for extrusion coating of a fiber-based substrate, wherein a twin-screw extruder is used on-line in the extrusion coating process.

### FIELD OF THE INVENTION

The present invention relates to a process for extrusion coating of a fiber-based substrate, wherein a twin-screw extruder is used on-line in the extrusion coating process.

### BACKGROUND

Fiber based products used as packages, such as liquid packages or food packages, must be able to withstand the influence of the packed items such as the influence of liquids and/or food on the fiber based product. One way is to provide the fiber based product with a barrier, for example a water or grease resistant barrier which makes the fiber based product more resistant against liquids and/or grease. Barriers are normally created by coating the fiber based substrate with a composition which gives the substrate barrier properties. Different coatings can be applied depending on the needed properties of the barrier. The most commonly used materials when forming a barrier on a fiber based product, are polyethylene (PE), polypropylene (PP), polyethylene terephthalate (PET), ethylene vinyl alcohol (EVOH) or ethylene vinyl acetate (EVA). The polymers can for example be laminated or extrusion coated to the fiber based product. Currently, most of the barrier coatings are manufactured with extrusion coating techniques and hence made off-line in a separate coating unit. Extrusion coating typically involves melting a polymer and extruding it through a flat die. After exiting the die, the melt curtain is laid down onto a fast moving substrate and quenched on a cold roll.

Carrying out the extrusion coating off-line is expensive since it requires extra handling of the reels and an additional converting step.

Another important property for a fiber based product comprising a barrier is that its strength and its bending resistance is good enough in order for a package to be formed.

Another important aspect in the manufacture of fiber-based products to be used for packages is the speed at which the fiber-based substrate can be coated as well as the properties of the coating obtained.

To achieve fiber-based materials suitable for use as packages, extrusion coating is one technology of particular interest. Ideally, such extrusion coating should be carried out at high line speeds, at low cost and with adequate properties of the coating and coated substrate.

In extrusion coating, it is essential to obtain sufficient adhesion between the polymer and the fiber-based substrate. To achieve that and other important properties, additives are mixed with polymer or polymers to obtain a material suitable for the extrusion coating.

The mixing between polymer and additive is a key element to be able to efficiently perform extrusion coating of fiber-based substrates.

To achieve the desired mixing of polymer and additives for extrusion coating, twin-screw extruders may be used off-line, i.e. not directly connected to the extrusion coating process. Twin-screw extruders may for example be used to prepare pellets comprising polymers and additives, such as in WO2004/092273. The pellets obtained are then transferred to the process line for extrusion coating where the pellets may be melted, introduced into a compounder and subsequently used in the extrusion coating process.

To the extent extruders are used on-line in extrusion coating processes, such extruders are single-screw extruders. This is illustrated in U.S. Pat. No. 5,938,648.

There are several disadvantages associated with the use of single-screw technology in extrusion coating. The high shear forces and temperatures typically used in the context of single-screw extruders can cause excessive degradation or even cross-linking of the polymer used. Therefore, single-screw extruders are only suitable for a limited range of polymers that can withstand the conditions typically used. Another disadvantage with the use of single-screw extruders is that it uniform dispersion of additives is difficult or impossible to achieve.

Traditionally, single-screw or occasionally twin-screw extruders are used in off-line operations to prepare masterbatches or compounds of polymers mixed with various additives. This approach typically involves high cost in view of the requirement to move the extruded material from the off-line setting to the machinery used for the extrusion coating. Alternatively, pre-made masterbatches can be purchased, which also involves significant cost.

Another disadvantage related to the use of single-screw extruders is that the mixing of additives with the polymer is often insufficient when using a single-screw extruder. This may lead to a polymer-additive blend which is not sufficiently homogenous and may ultimately negatively influence the quality and properties of the extrusion coated product.

There is thus a need for more efficient processes for extrusion coating, particularly processes that are adapted for high speed and continuous extrusion coating.

### SUMMARY OF THE INVENTION

It has surprisingly been found that the use of a twin-screw extruder on-line in a process for extrusion coating of a fiber-based substrate provides several advantages.

It has been found that the use of the twin-screw extruder provides improved efficiency of the extrusion coating process and many of the shortcomings of the existing technology can be overcome. In particular, the present invention avoids degradation and cross-linking of the polymer material in the extruder. In addition, the present invention provides improved mixing of the at least one polymer with the at least one additive, which improves the properties of the extrusion coated product. The use of a twin-screw extruder in on-line operations also enables higher extrusion coating speed. The output of material for the extrusion coating is significantly higher than when using a single-screw extruder. Thus enable higher line speeds in the extrusion coating. In some embodiments, increased line speed is beneficial for example for the adhesion of the coating to the fiber-based substrate.

It is thus an object of the present invention to provide a process for extrusion coating of a fiber-based substrate, characterized in that a twin-screw extruder is used on-line in the process for extrusion coating and that mixing of at least one polymer with at least one additive is carried out in the twin-screw extruder.

In one embodiment of the present invention, more than one polymer is mixed with the at least one additive in the twin-screw extruder.

In one embodiment of the present invention, more than one additive is mixed with the at least on additive in the twin-screw extruder.

In one embodiment of the present invention, at least one additive is in solid form. In one embodiment, at least one additive is in liquid form. In one embodiment, at least one additive is in gas form.

### BRIEF DESCRIPTION OF THE FIGURES

FIG. 1: extrusion coating of a fiber-based substrate.

### DETAILED DESCRIPTION

The present invention relates to a process for extrusion coating of a fiber-based substrate, characterized in that a twin-screw extruder is used on-line in the process for extrusion coating and that mixing of at least one polymer with at least one additive is carried out in the twin-screw extruder.

The fiber-based substrate to be used in accordance with the present invention can be any fiber-based substrate suitable for being extrusion coated. Examples of such fiber-based substrates include board and paper.

In one embodiment of the present invention, the fiber-based substrate is pre-treated prior to the extrusion coating. Such pre-treatment may involve flame treatment, plasma treatment, corona treatment and/or ozone treatment. The amount of coating applied by extrusion coating is, in one embodiment, 4-60 g/m², such as 15-30 g/m² or 6-30 g/m² or 8-30 g/m² or 6-30 g/m² or 6-12 g/m².

The twin-screw extruder to be used in accordance with the present invention can be any twin-screw extruder suitable for use in the context of extrusion coating. Such twin-screw extruders are commercially available. The twin-screw extruder will generally have to be selected such that it has a capacity sufficient for the speed of the extrusion coating since it will be used in on-line operations. The output from the extruder is preferably at least 100 kg/h.

The extrusion coating is preferably carried out at high line speeds. Preferably, the line speed is at least 100 m/min, more preferably at least 300 m/min, most preferably from 300 m/min to 700 m/min.

The term “on-line” as used herein refers to the use of the twin-screw extruder connected to an extrusion coating process and equipment for such process designed to run continuously, such as in connection with or as part of extrusion coating/extrusion lamination line or a paper or board machine. Thus, “on-line” is in contrast to “off-line”, which describes a process where the twin-screw extruder operates separately from an extrusion coating process and wherein the twin-screw extruder may operate batchwise and/or is used in the manufacture of a masterbatch such as in the form of pellets or granules, subsequently used in extrusion coating.

The polymer used in accordance with the present invention is any polymer suitable for use in extrusion coating of a fiber-based substrate. Examples of such polymers are polyolefines such as polyethylene (PE), low-density polyethylene (LDPE), polypropylene (PP), COC, polyesters such as polyethylene terephthalate (PET), polylactic acid (PLA) and biopolymers including starch-based materials, copolymers such as acetates, acrylates, acrylic acid, acrylonitrile, metacrylic acid, vinyl acetate, acrylate copolymers, high-barrier polymers such as ethylene vinyl alcohol (EVOH), polyamide, PVOH, PGA, polyvinyl alcohol (PVA), and polymers such as modified styrene, butadiene, fumaric or maleic diesters, cellulose esters, starch ethers, and biopolymers such as PLA, PBAT, PBS, PBSA, PHA.

In one embodiment of the invention, the polymer used is not subjected to pre-drying prior to being used in the extrusion coating. In traditional single screw extrusion coating moisture in polymer raw material is not accepted and therefore hydrophilic polymers (like polyesters, PA, EVOH, starch etc.) must be pre-dried before extrusion coating. In twin-screw extrusion drying can be avoided because moisture can be removed from the polymer melt by vacuum pumps during twin screw process. This can offer improved production efficiency, less energy consumption and improved coating performance,

The additive used in accordance with the present invention is any additive suitable for mixing with a polymer and suitable for use in extrusion coating of a fiber-based substrate. Examples of such additives are granulate form materials (e.g. polymers or polymer masterbatches), inorganic fillers, powder/dust form materials (e.g. CaCO₃, talc, kaoline, pigments such as TiO₂), flake form materials, liquid form materials (e.g. chain extenders, wax, tackifiers), gas form materials (e.g. CO₂, nitrogen), highly viscous materials, liquid materials, gases and other additives by various form such as surfactants, microfibrillated cellulose, foaming agents, glass, glass fibers, etc. The use of a twin-screw extruder enables the use of gaseous additives as well as wet cellulose materials and polyesters that have not been subjected to pre-drying. In one embodiment of the present invention, gaseous additives such as CO₂ and/or nitrogen as well as wet cellulose materials and at least one polymer that has not been subjected to pre-drying are mixed in the twin-screw extruder.

The amount of additive to be used in the process according to the present invention can be adjusted depending on the desired properties of the extrusion coated product and depends on the additive concerned. Typically, one or more additives are used. The total amount of additive is up to about 80% by weight of the material exiting the twin-screw extruder, such as up to 70% or up to 60% or up to 50% or up to 40% or up to 30% or up to 20% or up to 10% by weight of the material exiting the twin-screw extruder. Typically, the total amount of additive is at least 1% by weight of the material exiting the twin-screw extruder, such as at least 2% or at least 5% or at least 10% or at least 20% or at least 30% or at least 40% or at least 50% or at least 60% or at least 70% by weight of the material exiting the twin-screw extruder.

In one embodiment of the present invention, a controlled heat and shear gradient for the polymer is used in the twin-screw extruder during approximately ¾ of the length of the screw. The gradient is typically such that the maximum temperature and shear is applied at the end of the screw, i.e. just before the die. The use of such a gradient is typically beneficial for the adhesion properties between the fiber-based substrate and the coating being applied by extrusion coating.

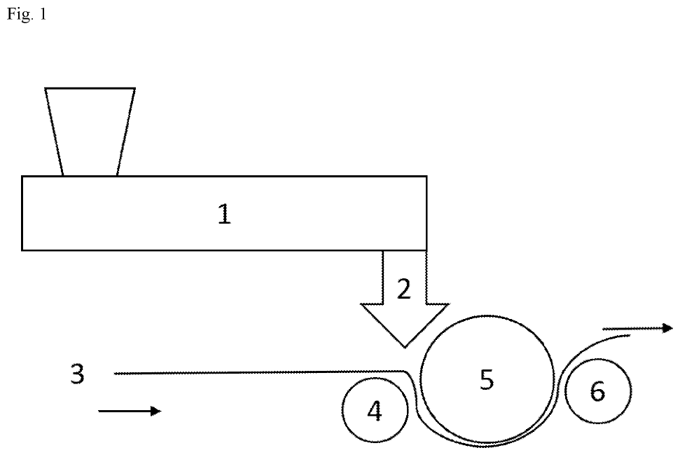

One embodiment of the present invention is illustrated in FIG. 1. A twin-screw extruder (1) is used to mix at least one polymer and at least one additive. The mixture between the polymer and additive exits the twin-screw extruder and passes a die (2) before being applied to the fiber-based substrate (3). The fiber-based substrate (1) passes a pressure roll (5) as the extrusion coating takes place and the coated fiber-based substrate is pressed between a cooling or chill roll (5) and a further pressure roll (6).

### EXAMPLES

### Example 1

A trial was performed, wherein a twin-screw extruder was used on-line in a process for extrusion coating of a fiber-based substrate.

The twin-screw was a 60 mm co-rotating twin-screw, L/D 40, max 600 rpm and the output was 100-1200 kg/h. The line speed was up to 25 m/min and the fiber-based substrate was pre-treated by electric corona treatment. The screw configuration was a low-energy input screw configuration for PET. The width was 700 mm in the form of a T-slot.

The fiber-based substrate used was commercially available Stora Enso Trayforma 190 g/m².

The coating was selected from:
LDPE
LDPE and fillers (CaCO₃, talc)
PET
PET and fillers (CaCO₃, talc)
PET and chain extenders
LDPE and foaming agent

The coating thickness was about 100 μm to 140 μm.

In view of the above detailed description of the present invention, other modifications and variations will become apparent to those skilled in the art. However, it should be apparent that such other modifications and variations may be effected without departing from the spirit and scope of the invention.

1. A process for extrusion coating of a fiber-based substrate, wherein a twin-screw extruder is used on-line in the process for extrusion coating and that mixing of at least one polymer with at least one additive is carried out in the twin-screw extruder.

2. The process according to claim 1, wherein the extrusion coating is carried out at a line speed of at least 100 m/min.

3. The process according to claim 1, wherein the output from the twin-screw extruder is at least 100 kg/h.

4. The process according to claim 1, wherein an amount of coating applied by extrusion coating is 4-60 g/m².

5. The process according to claim 4, wherein the amount of coating applied by extrusion coating is 6-30 g/m².

6. The process according to claim 1, wherein the at least one polymer is selected from the group consisting of: a polyolefin, polyethylene (PE), low-density polyethylene (LDPE), polypropylene (PP), COC, polyester, polyethylene terephthalate (PET), polylactic acid (PLA), biopolymers, starch-based materials, copolymers, acetates, acrylates, acrylic acid, acrylonitrile, metacrylic acid, vinyl acetate, acrylate copolymers, high-barrier polymers, ethylene vinyl alcohol (EVOH), polyamide, PVOH, PGA, polyvinyl alcohol (PVA), modified styrene, butadiene, fumaric or maleic diesters, cellulose esters, starch ethers, PBAT, PBS, PBSA, and PHA.

7. The process according to claim 1, wherein the at least one additive is in granulate form or a powder or dust material or a flake material or a liquid material or a gas material.

8. The process according to claim 7, wherein the at least one additive is selected from the group consisting of CaCO₃, talc, kaoline, a chain extender, wax, a tackifier, CO₂, nitrogen, a surfactant, microfibrillated cellulose, a foaming agent, glass, and glass fibers.

9. The process according to any claim 1, wherein an amount of additive is in the range of from 1% to 80% by weight of a material exiting the twin-screw extruder.

10. The process according to claim 1, wherein the fiber-based substrate is pre-treated prior to extrusion coating.

11. An apparatus for extrusion coating of a fiber-based substrate, comprising:
a twin-screw extruder configured for extrusion coating and configured to receive at least one polymer and at least one additive and mix the at least one polymer and the at least one additive.

12. The apparatus according to claim 11, wherein an output from the twin-screw extruder is at least 100 kg/h.

13. An extrusion coated fiber-based substrate obtained by a process according to claim 1.

14. A package comprising an extrusion coated fiber-based substrate according to claim 13.
